(19) United States
(12) Patent Application Publication
(10) Pub. No.: US 2009/0243958 A1
(43) Pub. Date: Oct. 1, 2009

(54) METHOD OF DISPLAYING DUAL IMAGES, DUAL DISPLAY DEVICE FOR PERFORMING THE METHOD AND DUAL DISPLAY MOBILE PHONE HAVING THE DUAL DISPLAY DEVICE

(75) Inventor: Kazuhiro MATSUMOTO, Tokyo (JP)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, (KR)

(21) Appl. No.: 12/330,987

(22) Filed: Dec. 9, 2008

(30) Foreign Application Priority Data
Mar. 25, 2008 (KR) 2008-27282

(51) Int. Cl. G09G 5/12

(52) U.S. Cl. 345/1.1

(57) ABSTRACT

A dual display device includes; a main display unit configured to exchange a main signal with an external system using a high-speed serial interface (“HSSI”) and to display a main image in response to the main signal, and a sub-display unit electrically connected to the main display unit and configured to exchange a sub-signal with the main display unit and to display a sub-image in response to the sub-signal, wherein display information for both the main display unit and the sub-display unit is contained in the main signal.

This application claims priority to Korean Patent Application No. 2008-27282, filed on Mar. 25, 2008, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention relate to a display device configured for displaying images and a mobile phone having the display device. More particularly, exemplary embodiments of the present invention relate to a method of displaying dual images capable of realizing a main image and a sub-image, a dual display device for performing the method and a dual display mobile phone having the dual display device.

2. Description of the Related Art

Generally, a dual display mobile phone denotes a folder-type mobile phone capable of displaying a main image when the dual display mobile phone is open and displaying a sub-image when the dual display mobile phone is closed.

The dual display mobile phone includes a main body including a central processing unit (“CPU”) and a dual display device electrically connected to the main body. The dual display device includes a main display unit displaying the main image and a sub-display unit displaying the sub-image.

The main body exchanges a signal with the dual display device to control the dual display device. Generally, the main body exchanges a signal with the main display unit and the sub-display unit, respectively, so that the main body controls each of the main display unit and the sub-display unit.

A high-speed serial interface (“HSSI”) mode, which is capable of communicating with other devices at a short distance at a high speed, may be employed in the dual display mobile phone.

However, in order to employ the HSSI mode, a plurality of wirings and a plurality of driving circuits, which are capable of communicating at a high speed, are employed in the dual display mobile phone. When the wirings and the driving circuits are employed in the dual display mobile phone, manufacturing costs of the dual display mobile phone may be increased.

### BRIEF SUMMARY OF THE INVENTION

Exemplary embodiments of the present invention provide a method of displaying dual images capable of reducing manufacturing costs while performing high-speed communication.

Exemplary embodiments of the present invention also provide a dual display device for performing the above-mentioned method of displaying dual images.

Exemplary embodiments of the present invention also provide a dual display mobile phone having the above-mentioned dual display device.

According to one exemplary embodiment of the present invention, a method of displaying dual images includes transmitting a main signal to a main display unit using a high-speed serial interface (“HSSI”), and transmitting a sub-signal from the main display unit to a sub-display unit based on the main signal, wherein display information for both the main display unit and the sub-display unit is contained in the main signal.

In one exemplary embodiment of the present invention, the sub-signal may be transmitted from the main display unit to the sub-display unit using a serial peripheral interface (“SPI”).

In one exemplary embodiment of the present invention, the sub-display unit may not display a sub-image when the main display unit displays a main image, and the main display unit may not display the main image when the sub-display unit displays the sub-image.

According to another exemplary embodiment of the present invention, a dual display device includes; a main display unit configured to exchange a main signal with an external system using an HSSI and to display a main image in response to the main signal, and a sub-display unit electrically connected to the main display unit and configured to exchange a sub-signal with the main display unit and to display a sub-image in response to the sub-signal, wherein display information for both the main display unit and the sub-display unit is contained in the main signal.

In one exemplary embodiment of the present invention, the sub-display unit may be configured to exchange the sub-signal with the main display unit using an SPI mode.

In one exemplary embodiment of the present invention, the main display unit may include; a main controller configured to output a main image output signal in response to the main signal, and to exchange the sub-signal with the sub-display unit, and a main image display part configured to display the main image in response to the main image output signal.

In one exemplary embodiment, the main controller may include; a main interface part configured to exchange the main signal with the main system and to output main image data and a sub-image signal in response to the main signal, a main image memory configured to receive the main image data from the main signal interface and to store the main image data, a main image driving part configured to output the main image output signal in response to the main image control signal and the main image data stored in the main image memory, and a connection interface part configured to exchange the sub-signal with the sub-display unit.

In one exemplary embodiment, the main controller may further include a sub-signal control part configured to receive a sub-control signal from the main interface part and to control an outputting of the sub-image signal from the main interface part to the connection interface part in response to the sub-control signal.

In one exemplary embodiment, the main image memory may be configured to store the sub-image signal from the main interface part, and to output the stored sub-image signal to the connection interface part as controlled by the sub-signal control part.

In one exemplary embodiment, the main image memory may include a main image storage sector configured to store the main image data, and a sub-image storage sector configured to store the sub-image signal.

In one exemplary embodiment, the main controller may further include a sub-signal memory configured to store the sub-image signal from the main interface part, and to output the stored sub-image signal to the connection interface part as controlled by the sub-signal control part.

In one exemplary embodiment, the sub-signal memory may be a first-in, first-out (“FIFO”) memory

In one exemplary embodiment, the sub-signal control part may be configured to control the output of the sub-image signal to the connection interface part, when the main interface part does not receive the main signal from the main system during a time-out interval.

In one exemplary embodiment, the sub-signal control part may include a time-out memory configured to store information about the time-out interval.

In one exemplary embodiment, the information of the time-out interval may be configured to be changed based on the sub-control signal to be stored in the time-out memory.

In one exemplary embodiment of the present invention, the sub-image signal may include a command code configured to control the sub-display unit, and sub-data including information for the sub-image.

In one exemplary embodiment, the sub-image signal may further include a terminator code indicating an end of the sub-data. In one exemplary embodiment, the main controller may be configured to count the sub-data to store the size of the sub-data in a memory of the main controller.

According to still another exemplary embodiment of the present invention, a dual display mobile phone includes; a main body including a central processing unit (“CPU”), and a dual display device including, a main display unit electrically connected to the main body and configured to exchange a main signal with the main body using an HSSI, and to display a main image in response to the main signal, and a sub-display unit electrically connected to the main display unit to exchange a sub-signal therewith, and configured to display a sub-image in response to the sub-signal.

According to the present invention, as a main display unit communicates with a main body by using an HSSI mode and further performs a hub function connecting the main body and a sub-display unit, a dual display mobile phone may perform high-speed communication between a dual display device and the main body. Moreover, manufacturing costs of the dual display mobile phone may be decreased.

### BRIEF DESCRIPTION OF THE DRAWINGS

The above and other features and advantages of the present invention will become more apparent by describing in detailed exemplary embodiments thereof with reference to the accompanying drawings.

FIG. 1 is a block diagram illustrating an exemplary embodiment of a dual display mobile phone according to the present invention;

FIG. 2 is a block diagram illustrating an exemplary embodiment of a dual display device of the exemplary embodiment of a dual display mobile phone of FIG. 1;

FIG. 3 is a block diagram illustrating an exemplary embodiment of a main controller of FIG. 2;

FIG. 4 is a block diagram illustrating an exemplary embodiment of a sub-controller of FIG. 2;

FIG. 5 is a block diagram illustrating another exemplary embodiment of a main controller further including a sub-signal memory;

FIGS. 6 and 7 are diagrams illustrating exemplary embodiments of a sub-image signal; and

FIG. 8 is a block diagram illustrating an exemplary embodiment of a sub-signal control part of the exemplary embodiments of a main-controller of FIGS. 3 and 5.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like reference numerals refer to like elements throughout. It will be understood that when an element is referred to as being “on,” another element, it can be directly on the other element or layer or intervening elements may be present therebetween. In contrast, when an element is referred to as being “directly on” another element, there are no intervening elements present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-sectional illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

FIG. 1 is a block diagram illustrating an exemplary embodiment of a dual display mobile phone according to the present invention. Referring to FIG. 1, an exemplary embodiment of a dual display mobile phone according to the present invention includes a main body MP and a dual display device DP. The dual display device DP exchanges a signal with the main body MP to display an image. In the present exemplary embodiment, the dual display device DP exchanges a main signal 10 with the main body MP in a high-speed serial interface (“HSSI”) mode to display an image in response to the main signal 10.

In one exemplary embodiment, the dual display device DP may be coupled to the main body MP in a folder-type arrangement. That is, the dual display mobile phone may be a folder-type mobile phone. In another exemplary embodiment, the dual display device DP may be coupled to the main body MP in a flip-type arrangement. That is, the dual display mobile phone may be a flip-type mobile phone. Alternative exemplary embodiments include other configurations wherein the dual display device DP may be coupled to the main body MP in other arrangements as would be apparent to one of ordinary skill in the art.

In the present exemplary embodiment, the main body MP wirelessly exchanges a signal with a communication base station. That is, the main body may receive an external electromagnetic signal from the communication base station and may transmit an internal electromagnetic signal to the communication base station.

The main body MP includes a central processing unit (“CPU”) processing externally supplied information included in the electromagnetic signal from the communication base station and processing internal information which may be included in the internal electromagnetic signal. In the present exemplary embodiment, the main body MP exchanges the main signal 10 using the HSSI mode with the dual display device DP in response to the external information and the internal information.

The dual display device DP includes the main display unit MDP, configured for displaying a main image, and a sub-display unit SDP, configured for displaying a sub-image. In one exemplary embodiment, the main display unit MDP and the sub-display unit may both be liquid crystal display (“LCD”) devices.

The main image may include main information which is required when the dual display device DP communicates with an external, different mobile phone, and the sub-image may include sub-information such as time, date, and various other similar information. Thus, the resolution of the sub-display unit SDP may be lower than that of the main display unit MDP.

The main display unit MDP is electrically connected to the main body MP to exchange the main signal 10 using the HSSI mode. The main display unit MDP displays the main image in response to the main signal 10.

Here, the HSSI mode denotes a communication method that is capable of communicating at a short distance at a high speed. In one exemplary embodiment, the HSSI mode may have a maximum transfer rate of about 52 Mbps. The HSSI mode may exchange a signal through about fifty connector points to communicate with other devices by using a differential emitter-coupled logic circuit.

The sub-display unit SDP is electrically connected to the main display unit MDP to exchange a sub-signal 20 with the main display unit MDP. The sub-display unit SDP displays the sub-image in response to the sub-signal 20. That is, in the present exemplary embodiment, the main signal 10 includes information for the main image and the sub-image.

In one exemplary embodiment, the sub-display unit SDP may exchange the sub-signal 20 with the main display unit MDP in a serial peripheral interface (“SPI”) mode. In such an exemplar embodiment, the SPI mode denotes a communication method capable of exchanging a plurality of signals through three wirings. That is, a first wiring is used when a signal is transmitted from the main display unit MDP to the sub-display unit SDP, a second wiring is used when a signal is transmitted from the sub-display unit SDP to the main display unit MDP, and a third wiring is used when a clock signal is transmitted from the main display unit MDP to the sub-display unit SDP.

In one exemplary embodiment, when the main display unit MDP displays the main image, the sub-display unit SDP may not display the sub-image. In addition, in one exemplary embodiment, when the sub-display unit SDP displays the sub-image, the main display unit MDP may not display the main image. That is, according to one exemplary embodiment, the dual display mobile phone may display the main image when the dual display mobile phone is open, and the dual display mobile phone may display the sub-image when the dual display mobile phone displays the sub-image when the dual display mobile phone is closed. Alternative exemplary embodiments include configurations wherein the main image and the sub-image may be simultaneously displayed.

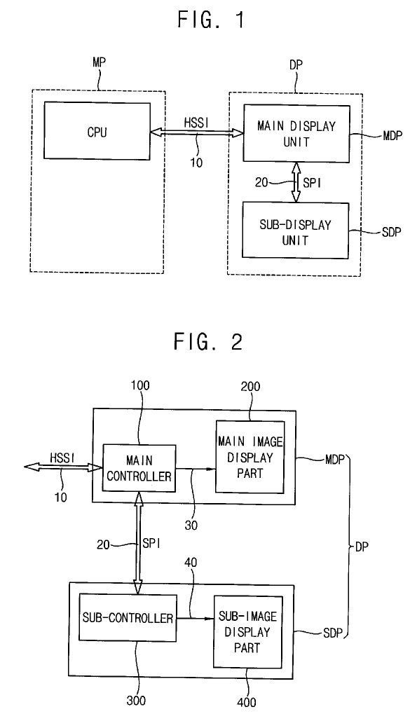

FIG. 2 is a block diagram illustrating an exemplary embodiment of a dual display device of the dual display mobile phone of FIG. 1. Referring to FIG. 2, a main display unit MDP includes a main controller 100 and a main image display part 200, and a sub-display unit SDP includes a sub-controller 300 and a sub-image display part 400.

The main controller 100 exchanges the main signal 10 with the main body MP of FIG. 1 by using the HSSI mode. The main controller 100 outputs a main image output signal 30 in response to the main signal 10. The main image display part 200 displays the main image in response to the main image output signal 30.

The sub-controller 300 exchanges the sub-signal 20 with the main controller 100 by using the SPI mode. The sub-controller 300 outputs a sub-image output signal 40 in response to the sub-signal. The sub-image display part 400 displays the sub-image in response to the sub-image output signal 40.

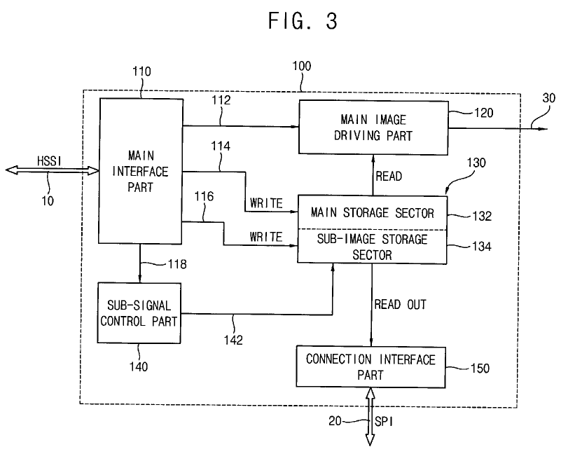

FIG. 3 is a block diagram illustrating an exemplary embodiment of a main controller 100 of FIG. 2.

Referring to FIG. 3, the main controller 100 may include a main interface part 110, a main image driving part 120, a main image memory 130, a sub-signal control part 140 and a connection interface part 150.

The main interface part 110 exchanges the main signal 10 with the main body MP of FIG. 1 by using the HSSI mode. The main interface part 110 may output a main image control signal 112, main image data 114, a sub-image signal 116 and a sub-control signal 118 in response to the main signal 10.

In one exemplary embodiment, the main interface part 110 may output the main image control signal 112 and the main image data 114 when the dual display mobile phone is open, and may output the sub-image signal 116 and the sub-control signal 118 only when the dual display mobile phone is closed. Alternatively, the main interface part 110 may output the main image control signal 112, the main image data 114, the sub-image signal 116 and the sub-control signal 118 when the dual display mobile phone is closed or open.

The main image driving part 120 receives the main image control signal 112 from the main interface part 110. The main image memory 130 stores the main image data 114 that is supplied from the main interface part 110. In one exemplary embodiment, the main image memory 130 may be a frame buffer capable of storing the main image data 114.

In one exemplary embodiment, the main image driving part 120 may read the main image data 114 stored in the main image memory 130. As a result, the main image driving part 120 may output the main image output signal 30 in response to the main image control signal 112 and the main image data 114. In one exemplary embodiment, the main image driving part 120 may include a main image controller, a main image driving driver, a direct current-to-direct current (“DC-DC”) converter, an oscillator, and various other components as would be apparent to one of ordinary skill in the art.

The main image memory 130 may store the sub-image signal 116 supplied from the main interface part 1 10. In one exemplary embodiment, the main image memory 130 may include a main image storage sector 132 which stores the main image data 114 and a sub-image storage sector 134 which stores the sub-image signal 116. In the present exemplary embodiment, the sub-image storage sector denotes an area of the main image memory 130 that is allocated to store the sub-image signal.

The sub-signal control part 140 receives the sub-control signal 118 from the main interface part 110. The sub-signal control part 140 controls the output of the sub-image signal 116 from the main interface part 110 to the connection interface part 150 in response to the sub-control signal 118.

In one exemplary embodiment, in response to the sub-control signal 118, the sub-signal control part 140 outputs a sub-output signal 142 for controlling an output of the sub-image signal 116 to the main image memory 130. The main image memory 130 outputs the sub-image signal 116 stored in the sub-image storage sector 134 to the connection interface part 150 in response to the sub-output signal 142. In the present exemplary embodiment, data that is stored first in the sub-image storage sector 134 is outputted earlier than data that is stored later, e.g., data is output sequentially.

The connection interface part 150 receives the sub-image signal 116 from the main image memory 130, and transmits the sub-signal 20 to the sub-controller 300 as shown in FIG. 2 in response to the sub-output signal 142.

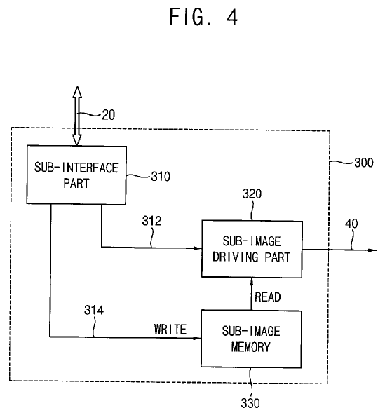

FIG. 4 is a block diagram illustrating an exemplary embodiment of a sub-controller of FIG. 2. Referring to FIG. 4, in one exemplary embodiment, the sub-controller 300 may include a sub-interface part 310, a sub-image driving part 320 and a sub-image memory 330.

The sub-interface part 310 exchanges the sub-signal 20 with the connection interface part 150 of FIG. 3 using the SPI mode. The sub-interface part 310 may output a sub-image control signal 312 and sub-image data 314 in response to the sub-signal 20.

The sub-image driving part 320 receives the sub-image control signal 312 from the sub-interface part 310. The sub-image memory 330 receives the sub-image data 314 from the sub-interface part 310 and stores it therein. In one exemplary embodiment, the sub-image memory 330 may be a frame buffer capable of storing the sub-image data 314.

The sub-image driving part 320 may read the sub-image data 314 stored in the sub-image memory 330. As a result, the sub-image driving part 320 may output the sub-image output signal 40 in response to the sub-image control signal 312 and the sub-image data 314. In one exemplary embodiment, the sub-image driving part 320 may include a sub-image controller, a sub-image driving driver, a DC-DC converter, an oscillator, and various other components as would be apparent to one of ordinary skill in the art.

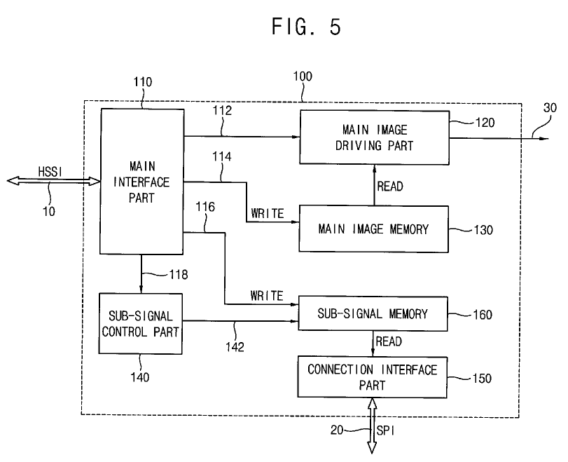

FIG. 5 is a block diagram illustrating another exemplary embodiment of a main controller 100 further including a sub-signal memory 150. The present exemplary embodiment of a main controller 100 is substantially similar to the main controller 100 shown in FIG. 3, and therefore similar reference numerals are used to illustrate similar components and the detailed description will focus on the differences between the exemplary embodiments. Referring to FIG. 5, the main controller 100 may further include a sub-signal memory 160 in addition to the main image memory 130. The main controller 100

In the present exemplary embodiment, the sub-signal memory 160 stores the sub-image signal 116 supplied from the main interface part 110. Here, the sub signal memory 160 may be a first-in, first-out (“FIFO”) memory in which data that is stored first is read first. This sub-signal memory 160 essentially replaces the sub-image storage sector 134 of the main image memory 130 shown in FIG. 3.

The sub-signal control part 140 receives the sub-control signal 118 from the main interface part 110. In response to the sub-control signal 118, the sub-signal control part 140 outputs a sub-output signal 142 to the sub-signal memory 160 for controlling output of the sub-image signal 116. The sub-signal memory 160 outputs the sub-image signal 116 stored therein to the connection interface part 150 in response to the sub-output signal 142.

Accordingly, when the main controller 100 further includes the sub-signal memory 160 in addition to the main image memory 130 a storage space capable of storing the sub-image signal 116 having information for a high resolution image may be ensured. That is, when the main controller 100 further includes the sub-signal memory 160, the sub-display unit SDP of FIG. 2 may realize a sub-image having a high resolution.

Moreover, in the exemplary embodiment wherein the main controller 100 further includes the sub-signal memory 160, the main display unit MDP and the sub-display unit SDP of FIG. 2 may display the main image and the sub-image, simultaneously.

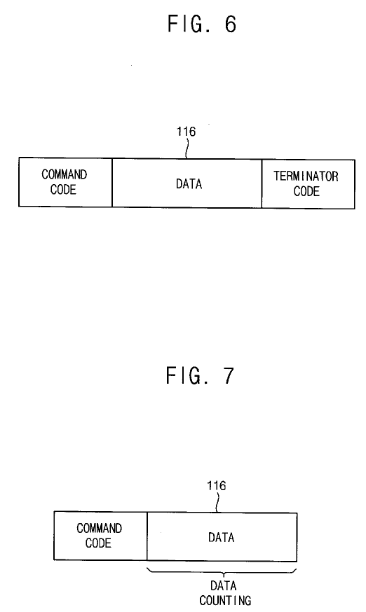

FIGS. 6 and 7 are diagrams illustrating exemplary embodiments of a sub-image signal.

Referring to FIG. 6, an exemplary embodiment of the sub-image signal 116 may include a command code for controlling the sub-display unit of FIG. 2 and sub-data including information for the sub-image. In the present exemplary embodiment, the sub-image signal 116 may further include a terminator code indicating an end of the sub-data. The terminator code may be a code indicating that data for one image group has ended. In such an exemplary embodiment, the main display unit MDP may transfer data to the sub-display unit SDP one image group at a time using the terminator code.

Referring to FIG. 7, the main controller 100 may count the sub-data to store the size of the sub-data to a memory of the main controller 100. In such an exemplary embodiment, the main interface part 110 or the sub-signal control part 140 counts the number of rows of the sub-data to store the number of rows of the sub-data in the sub-image storage sector 134 of the main image memory 130 as shown in FIG. 3. Alternatively, the main interface part 110 may store the number of rows of the sub-data in the sub-signal memory 160 as shown in FIG. 5.

The number of rows of the sub-data is a variable factor determining the size of one image group, so that the main display unit MDP may transfer data to the sub-display unit SDP through the number of rows of the sub-data.

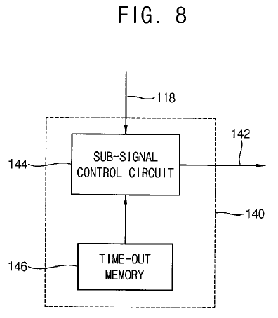

FIG. 8 is a block diagram illustrating an exemplary embodiment of a sub-signal control part of a main controller. Referring to FIGS. 3, 5 and 8, the sub-signal control part 140 may further perform a time-out function.

In such an exemplary embodiment, the sub-signal control part 140 may control the sub-image signal 116 to be outputted from sub-signal memory 160 to the connection interface part 150, when the main interface part 110 does not receive the main signal 10 from the main body MP of FIG. 1 during a time-out interval. That is, when the sub-signal control part 140 controls the output of the sub-image signal 116 stored in the sub-image storage sector 134 of the main image memory 130, or the sub-signal memory 160, to the connection interface part 150 when the main interface part 110 does not receive the main signal 10 from the main body MP during the time-out interval. Thus, the dual display device DP of FIG. 2 may display the sub-image, automatically.

In one exemplary embodiment, the sub-signal control part 140 may include a sub-signal control circuit 144 and a time-out memory 146. In such an exemplary embodiment, the sub-signal control circuit 144 outputs the sub-output signal 142 to the main image memory 130, or the sub-signal memory 160, in response to the sub-control signal 118 from the main interface part 110. The time-out memory 146 stores information of the time-out interval. The time-out memory 146 may provide the information of the time-out interval to the sub-signal control circuit 144. The sub-signal control circuit 144 may perform a time-out function by using information about the time-out interval provided by the time-out memory 146.

In one exemplary embodiment, the information of the time-out interval stored in the time-out memory 146 may be changed by a time-out changing signal of the sub-control signal 118. In one exemplary embodiment, the time-out memory 146 may be an erasable programmable read-only memory (“EPROM”).

According to the present invention, the main body exchanges a main signal with the main display unit of the dual display device using an HSSI mode at a relatively high speed, and the main display unit exchanges a sub-signal with the sub-display unit of the dual display device using an SPI mode at a relatively low speed. That is, the main display unit may perform a hub function that connects the main body and the sub-display unit.

Therefore, the dual display mobile phone in accordance with the present invention may exchange a signal between a main body and a main display unit at a high speed. In addition, a communication path between the main body and a sub-display unit may be removed, so that manufacturing costs of the dual display mobile phone maybe decreased.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of displaying dual images, the method comprising:
transmitting a main signal to a main display unit using a high-speed serial interface; and
transmitting a sub-signal from the main display unit to a sub-display unit based on the main signal,
wherein display information for both the main display unit and the sub-display unit is contained in the main signal.

2. The method of claim 1, wherein the sub-signal is transmitted from the main display unit to the sub-display unit using a serial peripheral interface.

3. The method of claim 1, wherein the sub-display unit does not display a sub-image when the main display unit displays a main image, and
the main display unit does not display the main image when the sub-display unit displays the sub-image.

4. A dual display device comprising:
a main display unit configured to exchange a main signal with an external system using a high-speed serial interface and to display a main image in response to the main signal; and
a sub-display unit electrically connected to the main display unit and configured to exchange a sub-signal with the main display unit and to display a sub-image in response to the sub-signal,
wherein display information for both the main display unit and the sub-display unit is contained in the main signal.

5. The dual display device of claim 4, wherein the sub-display unit is configured to exchange the sub-signal with the main display unit using a serial peripheral interface.

6. The dual display device of claim 4, wherein the main display unit comprises:
a main controller configured to output a main image output signal in response to the main signal, and to exchange the sub-signal with the sub-display unit; and
a main image display part configured to display the main image in response to the main image output signal.

7. The dual display device of claim 6, wherein the main controller comprises:
a main interface part configured to exchange the main signal with the main system, and to output main image data and a sub-image signal in response to the main signal;
a main image memory configured to receive the main image data from the main signal interface and to store the main image data;
a main image driving part configured to output the main image output signal in response to the main image control signal and the main image data stored in the main image memory; and
a connection interface part configured to exchange the sub-signal with the sub-display unit.

8. The dual display device of claim 7, wherein the main controller further comprises a sub-signal control part configured to receive a sub-control signal from the main interface part and to control an outputting of the sub-image signal from the main interface part to the connection interface part in response to the sub-control signal.

9. The dual display device of claim 8, wherein the main image memory is configured to store the sub-image signal from the main interface part, and to output the stored sub-image signal to the connection interface part as controlled by the sub-signal control part.

10. The dual display device of claim 9, wherein the main image memory comprises:
a main image storage sector configured to store the main image data; and
a sub-image storage sector configured to store the sub-image signal.

11. The dual display device of claim 8, wherein the main controller further comprises a sub-signal memory configured to store the sub-image signal from the main interface part, and to output the stored sub-image signal to the connection interface part as controlled by the sub-signal control part.

12. The dual display device of claim 11, wherein the sub-signal memory is a first-in, first-out memory.

13. The dual display device of claim 8, wherein the sub-signal control part configured to control the output of the sub-image signal to the connection interface part when the main interface part does not receive the main signal from the main system during a time-out interval.

14. The dual display device of claim 13, wherein the sub-signal control part comprises a time-out memory configured to store information about the time-out interval.

15. The dual display device of claim 14, wherein the information of the time-out interval is configured to be changed based on the sub-control signal.

16. The dual display device of claim 7, wherein the sub-image signal comprises:
a command code configured to control the sub-display unit; and
sub-data including information for the sub-image.

17. The dual display device of claim 16, wherein the sub-image signal further comprises a terminator code indicating an end of the sub-data.

18. The dual display device of claim 16, wherein the main controller is configured to count the sub-data to store the size of the sub-data in a memory of the main controller.

19. A dual display mobile phone comprising:
a main body including a central processing unit; and
a dual display device including:
a main display unit electrically connected to the main body and configured to exchange a main signal with the main body using a high speed serial interface, and to display a main image in response to the main signal; and
a sub-display unit electrically connected to the main display unit to exchange a sub-signal therewith, and configured to display a sub-image in response to the sub-signal,
wherein display information for both the main display unit and the sub-display unit is contained in the main signal.

20. The dual display mobile phone of claim 19, wherein the sub-display unit exchanges the sub-signal with the main display unit using a serial peripheral interface.
